(19) United States
(12) Patent Application Publication
(10) Pub. No.: US 2003/0212565 A1
(43) Pub. Date: Nov. 13, 2003

(54) Appraisal and home inspection process

(76) Inventors: Robert C. Badali, McKinney, TX (US); Greg A. Dennis, Allen, TX (US); Brad Meyer, Colleyville, TX (US)

Correspondence Address: Peter F. Weinberg, Gibson, Dunn & Crutcher LLP, Suite 4100, 1801 California Street, Denver, CO, 80202, US

(21) Appl. No.: 10/140,008

(22) Filed: May 8, 2002

(51) Int. Cl. G06F 17/60

(52) U.S. Cl. 705/1

(57) ABSTRACT

A process for performing a home evaluation and appraisal for a subject property is described. A home inspector performs a traditional home inspection with respect to the property, and also performs an evaluation of subjective criteria related to the property. The home inspector transmits this information to a separate appraiser. The appraiser performs an appraisal of the house using an automated valuation model (AVM) based upon publicly available information. The appraiser then adjust the appraisal generated by the AVM using the information obtained by the inspector. As an additional aspect of the invention, insurance may be offered such that a party buying the property based upon the adjusted appraised value is insured in the event such party is unable to resell the property for an amount equal to the adjusted appraised value within a prereselected amount of time. The invention has particular applicability in the field of an employer home buyout for a relocated employee.

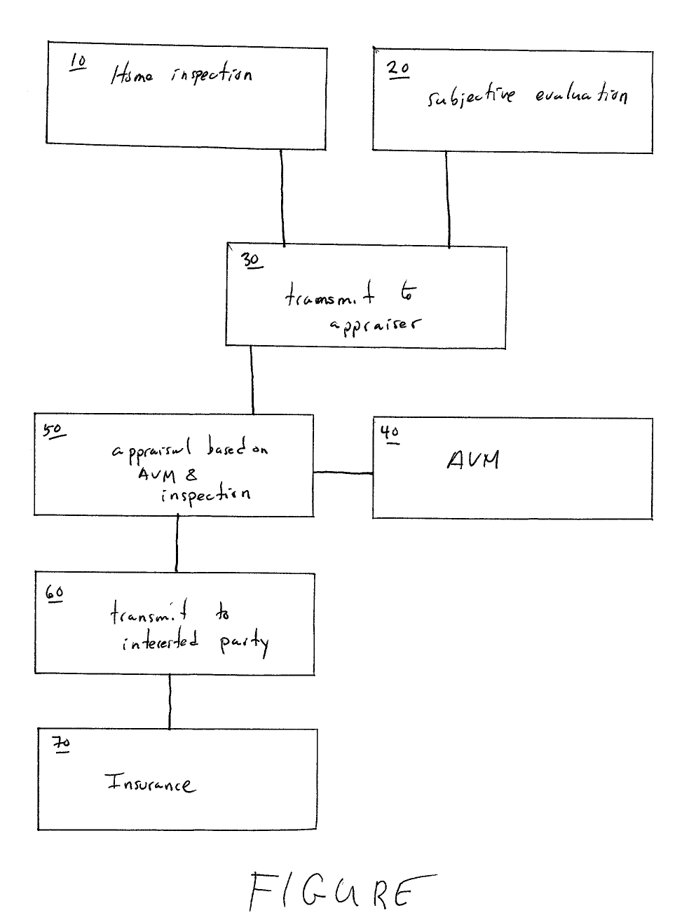

### FIELD OF THE INVENTION

The present invention relates to the field real estate appraisals and home inspections conducted therewith. The invention has particular applicability to appraisals and inspections performed in connection with a property that is being purchased by an employer as part of an employee relocation.

### BACKGROUND

In a large corporation, it is frequently necessary to transfer an employee to a new geographic area, requiring the employee to relocate. If the employee owned a house before the transfer, he will often sell his house and buy a new house in the new area. While it is of course not necessary that the employer play a role in this transaction, an employer frequently is involved in this process to minimize the inconvenience to the employee and to induce the employee to cooperate with the relocation. As an employee is often reluctant to relocate in the first place, an employer must be sensitive to the needs of the employee or else risk that the employee will not relocate. At the same time, the employer wishes to minimize the expenses incurred in the relocation process.

A common form of relocation assistance is a buyout, where the employer purchases the employee's property, and then resells the property to any interested third party. While the buyout may at first seem economically inefficient as the employer is purchasing property merely to immediately resell it, it has several advantages in the context of employee relocation. Often an employee will not be able to purchase a new house until his original house is sold. An immediate sale therefore allows the quick purchase of new house in the area of relocation, thereby avoiding the necessity of a costly short term rental or a delay in the relocation process. Also, the process the selling a house can be stressful, even when real estate broker is engaged. The seller must frequently negotiate with more than one prospective purchaser, and may receive competing offers that are not directly comparable because of contingencies and other factors. Even when the process goes relatively smoothly, a typical employee makes only several purchases and sales of real estate in his life, and is not an expert in that field. This unfamiliarity combined with the relatively large dollar amounts involved with real estate, as expressed in terms of a typical employee's salary, adds to the stress to the employee. Because the relocating employee may also be stressed and unusually busy because of new work responsibilities, the employer desires to minimize the inconvenience and time spent by the employee in connection with real estate transactions. Providing the employee with a ready, willing, and able buyer in the form of the employer enables the employee to devote more time and energy to his work. Further, the cost of the house is relatively small to the employer as compared to the employee, so the employer is more able to delay the sale of the house until a favorable buyer appears. While the buyout system is generally advantageous for both the employer and the employee, it will be appreciated that the employer will still desire to minimize the costs involved in the process. Those costs include the price paid to the employee for property, which ideally is recaptured upon resale, and ancillary transaction costs.

In order for the employer to purchase the property from the employee, a purchase price must be reached. This is most commonly done by having several appraisals performed, and selecting the average appraisal value. The appraisals are performed by professionals who provide their services for a fee, such as at a current cost of about $500 per appraisal. As the company pays these services as a part of the transaction costs which cannot be recovered upon sale of the property, it would be desirable to minimize these costs, particularly if that could be done without impairing accuracy of the appraisal. Finally, it should be clear that the employer is accepting some risk in that it may be unable to sell the house to a third party for an amount equal to or greater than the price it pays to the employee. While there is also potential upside to the employer if it can sell the house for a greater amount, this speculation is generally not a desirable risk for the employer, particularly as the transaction with the employee is not completely at arm's length and the employer may not benefit from purchasing the property from the employee at an artificially low price, as the employer will become upset with the employer if he learns of this profit by the employer. It would therefore be beneficial if the employee could have some certainly that the property could be sold for appraised value. It is also desirable if the appraisal process can be completed as quickly as possible, so the transaction can occur quickly and the employee can purchase a new house.

In addition to an appraisal, the employer will generally have a home inspection performed prior to purchasing the property. A home inspector is typically charged with determining whether a particular property has any mechanical or structural problems which would need to be corrected for (or accounted for in price) before the property could be sold. While the result of the home inspection may impact the value of the property, it is performed separate and apart from an appraisal. Of course, the employer must pay the home inspector for his services, thereby increasing the transaction costs. The employer could forgo an inspection, but would then risk over-paying for property if it contains a defect which would not be disclosed by a typical appraisal.

While there has been inventive activity with respect to developing automated valuation models for real estate, to the knowledge of the applicant none of these have addressed certain inefficiencies inherent in the process as it is currently known. A process which could streamline and reduce the transaction costs associated with a property buyout and also reduce the risk to the employer would be a welcome advance in the art. It is an object of the present invention to provide such a process. All documents referred to in the attached information disclosure statement (Form 1449) are hereby incorporated by reference in their entirety, although no documents are admitted to render any of the claims unpatentable either alone or in combination with any other references known to the applicant.

The present invention is described in connection with a buyout of an employee's property by an employer. However, it will be appreciated that the invention also has applicability to other appraisals, such as may be performed in connection with mortgages and refinancing.

### SUMMARY

An embodiment of the invention is a process for appraising a subject real estate property. The invention includes the steps of performing a home inspection of the property by a home inspector; performing a subjective evaluation of the property by the same home inspector; recording and transmitting the results of the inspection and evaluation to an appraiser, wherein the appraiser is not the home inspector; performing an appraisal of the property using an automated valuation model, which uses publicly available records related to the property, this step being performed by the appraiser; and adjusting the appraisal using the results of the subjective evaluation of the inspector to generate an adjusted appraisal, this step being performed by the appraiser. Another embodiment includes the steps of transmitting the adjusted appraisal value to a potential purchaser of the property, and offering an insurance option to the potential purchaser wherein the potential purchaser shall be reimbursed an amount based upon the difference in the adjusted appraisal value and an amount that the potential purchaser obtains by selling the property within a predefined period of time if such amount is less than the adjusted appraisal value. In another embodiment, the step of transmitting the inspectors results to the appraiser is performed using electronic media such as a database program, and is accessible over the Internet.

In other embodiments, the invention is practiced in the context of a buyout of an employee's property by an employer, such as occurs in an employee relocation.

### BRIEF DESCRIPTION OF THE DRAWING

The FIGURE is a flow chart of the process steps of an embodiment of the present invention.

### DETAILED DESCRIPTION

The present invention is a process for appraising real estate in connection with a home inspection. In a preferred embodiment, the appraisal and home inspection are performed in connection with a property buyout for a relocated employee by an employer In such a buyout, the employer arranges for an appraisal of the property by an appraiser, and purchases the property at the appraised value.

The first step in the process of the present invention is a home inspection of the subject property by a home inspector. The home inspector provides a typical home inspection, which includes inspection of the property with a view towards determining whether the property has major structural, mechanical, or electrical problems which would detract from the value of the home. For example, the home inspector examines the property's HVAC system to determine that it is in proper working order and does not require any immediate repairs, and examines the foundation of the house to determine that there are no unacceptable structural flaws. The above are typical items inspected by a home inspector, and he may perform any such inspection as is known in the art.

The second step in the process of the present invention is a subjective inspection of the property by the home inspector. This subjective inspection includes factors which are outside of the domain of a typical home inspection. In particular, the home inspector considers subjective criteria such as the views from the subject property, advantageous location, heavy street traffic, landscaping quality, overall appeal, garage size, patios, pools/spas, and upgrades such as a designer kitchen, premium appliances, or other features affecting the value of the property. (By advantageous location, it is meant a desirable location within a given neighborhood, such as a corner lot). Further, the home inspector calculates the square footage of the house. Square footage is often available from sources such as country records; however, direct measurement often yields different numbers. There is some subjectivity to the determination of square footage. The significant point is that the measurement is made by the home inspector.

It is a significant aspect of the invention that this second step is performed by the same person who performs the home inspection, even though this second step is not in fact an activity typically performed by a home inspector.

Preferably, the subjective inspection factors are used by the inspector to complete a standardized form. The form includes field corresponding to the various subjective criteria, as well as fields corresponding to the home inspection data. The form is preferably an electronic form such as may be embodied in any computer database program.

The data collected by the home inspector is then transmitted to an appraiser. Assuming the form is an electronic form, it may be transmitted to the appraiser via a computer network such as the Internet. This allows for the appraiser to obtain the information quickly and inexpensively.

The appraiser next prepares an appraisal of the subject matter, including (ultimately) the information obtained from the inspector and the information obtained from an automated valuation model (AVM). First, the appraiser generates an appraisal value using an AVM. The AVM may be of any type known in the art. In general, an AVM provides an appraised value by comparing a subject property with the known sale prices of other properties in a database, using a number of objective criteria. Generally the starting point for an AVM is to determine the sale price of houses within the same predefined geographic area, such as in the same zip code, within a predefined time limit, such as 3 months. Depending upon the AVM, other, generally objective, criteria is considered such as the size of the lot, number of bathrooms, and the presence and size of a garage. The AVM provides an apprised value. As noted, this can be according to any known AVM. As an example of a very simple AVM, the average price per square foot of properties sold in the same zip code in the past three months could be calculated, and multiplied by the number of square feet of the subject property to determine the AVM appraised value.

The appraiser then performs an adjustment to the AVM using the subjective criteria and the calculated square footage information provided by the inspector. For example, if the calculated square footage differs from the square footage obtained from public records, a positive adjustment can be made. Or, if the home inspector noted that the kitchen is in need of an upgrade in order to match the overall quality of the house, a negative adjustment could be made. It is important to note that the subjective information (including the calculation of square footage) is not information that would typically be provided by a home inspector. Instead, it would typically have been learned by an appraiser in a personal visit to the subject property. The present invention renders the personal visit unnecessary. The specific adjustment to the AVM depends to some extent upon the specific skills of the appraiser. Additionally, the appraiser can determine the specific value of items by comparing the difference in price between two (or more) other properties, at least one of which has, and one of which does not have, the specific item. For example, if the subject property has a pool, the pool can be valued by comparing 2 similar properties, one of which has a pool and the other of which does not. The pool can be valued as the difference in sale price between the two properties.

It should be understood that the above described steps need not be performed in any particular order, unless logically required. For example, the AVM appraised value could be performed during or after the home inspector performs his inspection. As well as providing cost savings, it will be appreciated that the combination of the home inspection and gathering of appraisal information adds to the convenience of the employee and/or his family, as the property must only be made available on one occasion as opposed to the several occasions previously required.

Another aspect of the present invention is providing insurance to the employer for any difference between the price the employer pays the employee for the house and the price the employer obtains in a sale to a third party within a specified time. For example, assume the appraised value of a house according to the present invention is $250,000, and that is the purchase price paid by the employer. The employer is then able to sell for the house for only $200,000 within a predetermined time limit. The incurrence element of the present invention will cause the insurer to pay the employer the difference of $50,000. Variants may also be employed; for example, the insurance element may provide for a payment of some percentage of the difference, such as 50%, to the employer. In a preferred embodiment of the invention, the insurer is the same entity (or a legally affiliated entity) that employs or contracts with the home inspector and the appraiser. This allows the employer to contract with a single entity to obtain an appraisal, and be insured against the effect of too low of an appraisal. If desired, the employer could make arrangements to remit some or all money obtained in excess of the appraisal if the employer is able to sell the property for a larger amount. The insurance element of the present invention is particularly effective because it reduces the need for multiple appraisals. An employer may be somewhat reluctant to adopt the present invention (or, put another way, to engage a relocation specialist who employs the present invention), believing that multiple appraisals is likely to provide more accurate information, even though those multiple appraisals can only be obtained at considerable expense to the employer and inconvenience to the employee. However, an employer may be more willing to adopt the present invention with the knowledge that a negative difference in sale price will be insured.

The invention may also be understood with reference to the FIGURE. In step 10, a home inspector performs a home inspection of a subject property, and records the results of the home inspection. In step 20, the home inspection performs a subjection evaluation of the property, and records the results. The subjective evaluation includes aspects such as noting whether the property has positive or negative characterizes with respect to attributes such as view, location, landscaping, etc. in comparison with other properties located in a the same area. Steps 10 and 20 are performed during a single visit.

In step 30, the home inspector transmits the results of steps 10 and 20 to an appraiser. This step is preferably performed by having the inspector complete a predefined electronic form such as may be constructed using a database program, such that the form is accessible over the Internet.

In step 40, the appraiser generates an appraisal of the property using an automated valuation model, which includes publicly available data (i.e., data which is available without physically inspecting the property) such as the physical location of the property, and publicly available square footage. In step 40, the appraiser does not actually physically inspect the subject property.

In step 50, the appraiser generates an appraisal of the property using the results of the AVM, and also using the information learned by the home inspector in step 20, thereby generating an appraisal which is based upon the AVM appraisal and the subjective information.

In step 60, the appraisal generated in step 40 is transmitted to a prospective purchaser of the property, such as an employer who will purchase the property as a buyout of an employee's property in connection with a corporate relocation. In step 70, insurance is offered to the employer. The insurance will pay the employer the difference (or an amount calculated based at least in part upon the difference) between the appraisal value and the value at which the employer is able to sell the property (assuming this value is lower) within a predetermined amount of time. The insurance may have a deductible or any feature as is known in the art.

It should be appreciated that a number of inventive features have been disclosed herein. While a presently preferred embodiment of the invention includes all of the disclosed features, some of the features may also be practiced independently of the others.

The invention claimed is:

1. A process for appraising a subject real estate property comprising the steps of:
a) performing a home inspection of the property by a home inspector;
b) performing a subjective evaluation of the property by the same home inspector;
c) recording and transmitting the results of steps a and b to an appraiser, wherein the appraiser is not the home inspector;
d) performing an appraisal of the property using an automated valuation model, which uses publicly available records related to the property, this step being performed by the appraiser; and
e) adjusting the appraisal of step d using the results of the subjective evaluation of step b to generate an adjusted appraisal, this step being performed by the appraiser.

2. The process of step 1, further comprising the steps of transmitting the adjusted appraisal value to a potential purchaser of the property, and offering an insurance option to the potential purchaser wherein the potential purchaser shall be reimbursed an amount based upon the difference in the adjusted appraisal value and an amount that the potential purchaser obtains by selling the property within a predefined period of time if such amount is less than the adjusted appraisal value.

3. The process of step 1, wherein step c is performed using electronic media such as a database program, and is accessible over the Internet.

4. The process of step 1, wherein the subjective evaluation includes recording information related to the property's advantageous location, landscaping, presence of pools or spas, and presence of upgrades.

5. The process of step 1, wherein the property includes a house and the home inspector measures the square footage of the house.

6. The process of step 1, wherein an action such as a sale is performed based on said adjusted appraisal, and no other appraisal is performed in connection with said action.

7. A process for performing a buyout of an employee's property by an employer, comprising the steps of:
a) performing an appraisal and home inspection of an employee's property, said appraisal including
i) performing a home inspection of the property by a home inspector;
ii) performing a subjective evaluation of the property by the same home inspector;
iii) recording and transmitting the results of steps a and b to an appraiser, wherein the appraiser is not the home inspector;
iv) performing an appraisal of the property using an automated valuation model, which uses publicly available records related to the property, this step being performed by the appraiser; and
v) adjusting the appraisal of step d using the results of the subjective evaluation of step b to generate an adjusted appraisal, this step being performed by the appraiser; and
b) selling the property from the employee to the employer for a price based upon the adjusted appraisal.

8. The process of claim 7, further comprising the step of providing insurance to the employer such that the employer is reimbursed in the event that the employer is unable to sell the property for an amount equal to or greater than the adjusted appraisal within a predetermined amount of time.

9. The process of claim 7, wherein no additional appraisal or home inspection is performed related to buyout.
